(19) United States
(12) Patent Application Publication
(10) Pub. No.: US 2009/0251332 A1
(43) Pub. Date: Oct. 8, 2009

(54) MONITORING SYSTEM

(76) Inventor: David Douglas Senogles, Benoni (ZA)

Correspondence Address: COOK ALEX LTD, SUITE 2850, 200 WEST ADAMS STREET, CHICAGO, IL, 60606, US

(21) Appl. No.: 12/350,026

(22) Filed: Jan. 7, 2009

(30) Foreign Application Priority Data
Jan. 7, 2008 (ZA) 2008/00016

(51) Int. Cl. G08C 15/06; G08B 21/00

(52) U.S. Cl. 340/870.02; 340/540

(57) ABSTRACT

A monitoring arrangement for use in an underground excavation includes an elongate support unit between walls in the excavation. A load-responsive sensing arrangement can be included and can be placed on the elongate support unit. A control system monitors the sensing arrangement and an alarm can be activated.

### BACKGROUND OF THE INVENTION

This invention is generally concerned with an apparatus for and a method of monitoring certain conditions in an underground excavation and more particularly is concerned with an apparatus for and a method of sensing a load which, in use, is placed on a support arrangement installed in the underground excavation.

In an underground excavation use is normally made of one or more support structures to brace a hanging wall relative to a footwall. The support structure usually includes support props which are telescopically extensible.

Primarily the function of the support props is to control, in yielding fashion, movement of the hanging wall towards the footwall.

A difficulty with some existing support systems is that the systems may unexpectedly fail without any easily discernable prior warning. To assist in predicting a dangerous situation it would be useful to have information on the load which is carried by each support, and on the closure or other movement of the support.

An object of the invention is to provide data which is usable to assess the safety of an underground support structure.

### SUMMARY OF INVENTION

The invention provides a monitoring arrangement which includes an elongate unit, a sensing arrangement which is responsive to load which in use is placed on the unit, and a first control unit which monitors the sensing arrangement.

Preferably the monitoring arrangement includes a mechanism for logging or transmitting data received from the sensing arrangement. The mechanism may include a transmitter.

The unit may be telescopically extensible and may include a lower member and an upper member which is slidably engaged with the lower member.

The sensing arrangement may include a first sensor which senses longitudinal movement of one end of the elongate unit relative to an opposing end. Preferably the sensing arrangement includes a first sensor which senses longitudinal movement of the lower member relative to the upper member. The first sensor may include a wheel or any other measuring device which operates on an outer surface of one member and a spring or other arrangement which biases the mechanism towards the outer surface. Preferably the mechanism is placed at an interface between the upper and lower members.

The sensing arrangement may further include a pod which can be pressurised so that the unit is pre-stressed. A second sensor may sense the internal pressure of the pod. The pod may be placed between an end of the unit and an opposing rock surface.

The monitoring arrangement may include an alarm enunciator which is activated upon at least one of the following: movement of one end of the prop relative to an opposing end beyond a predetermined distance, or in excess of a predetermined rate; and when the force on the prop, in an axial direction, exceeds a predetermined level.

The enunciator may be operable in response to the first control unit.

The invention also extends to a method of monitoring a support arrangement which includes the steps of installing a sensing arrangement on an elongate unit in a support location, connecting a first control unit to the sensing arrangement, and monitoring the sensing arrangement with the control unit to determine a load which in use is placed on the unit.

The method may include a step of transmitting data received from the sensing arrangement to a second control unit. The second control unit may be situated at a location remote from the sensing unit.

The method may include the step of using data, received by the second control unit, to control at least one of the following: activating an alarm system; deactivating an alarm system; and transmitting data from the second control unit.

The method may include the step of retrieving a unique identifier from a memory of the first control unit, and transmitting the unique identifier and data from the sensing arrangement.

The invention further extends to a support monitoring system which includes at least a first elongate unit, in a support location, with a sensing arrangement which determines a load placed on the first unit during use, a first control unit which monitors the sensing arrangement, a mechanism for transmitting data from the sensing arrangement, and a second control unit which receives the data and which stores the data in memory.

The system may include at least a second elongate unit, and apparatus for detecting movement of at least part of the first elongate unit transversely to the second elongate unit.

Data on such relative transverse movement may be directed to the transmitting mechanism.

The apparatus may comprise any appropriate means to detect relative transverse movement (i.e. movement which takes place in a direction which is not coincident with a longitudinal dimension of one of the elongate units) e.g. a distance measuring device based on the use of electromagnetic signals (RF, laser or other light signals) or a cord or linkage which extends between two units and arranged so that a change in the tension or slack in the cord or linkage is indicative of relative transverse movement of the elongate units.

The invention also extends to a method of monitoring an underground excavation which includes the steps of installing at least one unit at a support location in the excavation between a hanging wall and an opposing footwall, monitoring the unit to obtain a first measure which is indicative of closure of the hanging wall and the footwall, and a second measure of a load on the unit, and generating an alarm if the first measure exceeds a predetermined value or takes place at a rate which is in excess of a predetermined rate, or if the second measure exceeds a predetermined level.

Preferably a plurality of units are installed in the excavation and the method includes the steps of transmitting at least the first measure of each unit to a remote location and logging the respective first measures at the remote location.

The method may include the step of analysing data, relating to the first measure, at the remote location.

The method may include the step of transmitting a signal to the excavation so that an alarm is activated when the analysed data indicates a dangerous condition. The alarm may be a visual alarm, or an audible alarm, or both.

The method may include the steps of monitoring the units to detect transverse movement of one unit relative to at least one other unit, and generating an alarm when such movement takes place.

The method may include the step of using the alarm signal to activate a light on at least one helmet, belt or other item, which may be worn by a miner.

### BRIEF DESCRIPTION OF THE DRAWINGS

The invention is further described by way of examples with reference to the accompanying drawings in which:

FIG. 1 is a side view of a monitoring arrangement which includes a unit according to the invention;

FIG. 2 is an enlarged view of a portion of the unit which is indicated by means of an arrow marked 2 in FIG. 1;

FIG. 3 is an enlarged view of a portion of the unit which is indicated by means of an arrow marked 3 in FIG. 1;

FIG. 4 is a flow chart of steps which are carried out by the monitoring arrangement;

FIG. 5 is a schematic representation of a system for monitoring a plurality of units installed in an underground excavation;

FIG. 6 is a perspective view of a different embodiment of a unit for use in a monitoring arrangement according to the invention, in which an alarm system, associated with the unit, has been activated;

FIG. 7 is a flow chart of steps in an alarm activation process;

FIG. 8 is a variation of an alarm system used in the invention; and

FIG. 9 illustrates a further possible feature of the invention.

### DESCRIPTION OF PREFERRED EMBODIMENTS

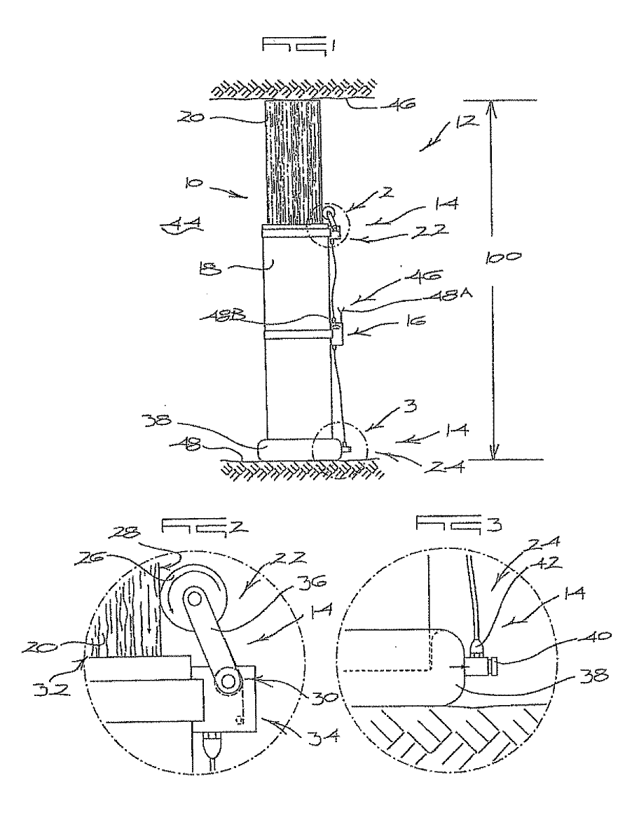

FIG. 1 of the accompanying representations illustrates a monitoring arrangement 10 according to the invention which includes an elongate unit 12, a sensing arrangement 14 which is responsive in use to load and which is installed on the unit, and a first control unit 16 which monitors the sensing arrangement.

The elongate unit 12 includes a lower member 18 and an upper member 20 which is telescopically engaged with the lower member. In this example the upper member is manufactured from a suitable wood material or from any other suitable material such as a metal. The material used in the lower member is chosen so that the lower member can withstand the internal pressures which are generated during the yielding action of the prop.

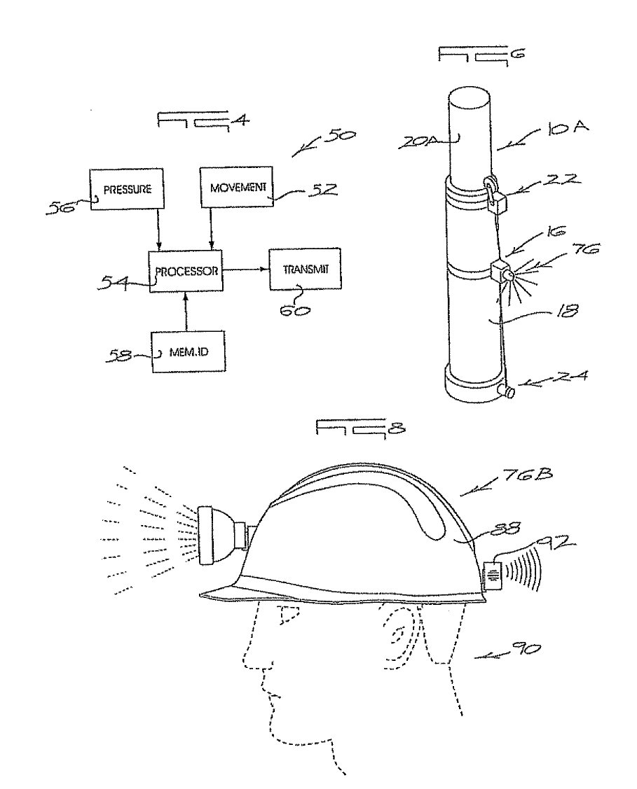

The sensing arrangement 14 has a first sensing mechanism 22, which is shown on an enlarged scale in FIG. 2, and a second sensing mechanism 24 which is shown on an enlarged scale in FIG. 3. The first mechanism includes a wheel 26 which runs on an outer surface 28 of the upper member 20. A spring arrangement 30 is used to bias the wheel towards the outer surface. The first mechanism is mounted at an interface 32 between the lower and upper members 18 and 20. Electronic circuitry 34 of the first sensor is mounted close to an upper end of the lower member with a short wheel brace extending therefrom. This ensures that the first mechanism is compact.

The sensing mechanism 24 comprises a conventional pod 38 which has a pressure regulating valve 40 and a pressure sensor 42 which is attached to the valve so that the internal pressure of the pod can be sensed by the pressure sensor.

The unit in a compact form is transported to a location in the underground excavation 44 at which installation is to take place. The pod is positioned between a lower end of the lower member 18 and the footwall 48. An upper end of the upper member is then moved into engagement with the hanging wall 46. An internal volume, not shown, of the lower member is then pressurised to extend and pre-stress, to some extent, the unit 12. The pod is thereafter pressurised so that the unit is further pre-stressed. The lower member has a valve or mechanical arrangement, not shown, which allows the unit to yield progressively at a controlled rate. This aspect is substantially conventional.

Once the unit 12 has been installed, the first control unit is installed at any selected location along the length of the lower member 20 and is connected using suitable wires to the first sensing mechanism 22 and to the sensing mechanism 24. The connecting wires can be located inside a protective sleeve or harness, not shown, so that the likelihood of damage to these wires during normal mining activities in the underground excavation 44 is reduced. The first control unit includes a mechanism 46 which is used to log or transmit data received by the first control unit from the sensing arrangement 14. Preferably the mechanism includes a transmitter 48A which is used to transmit to a remote location the sensing arrangement data. A memory component 48B can be used for the storage of data sent by the first control unit.

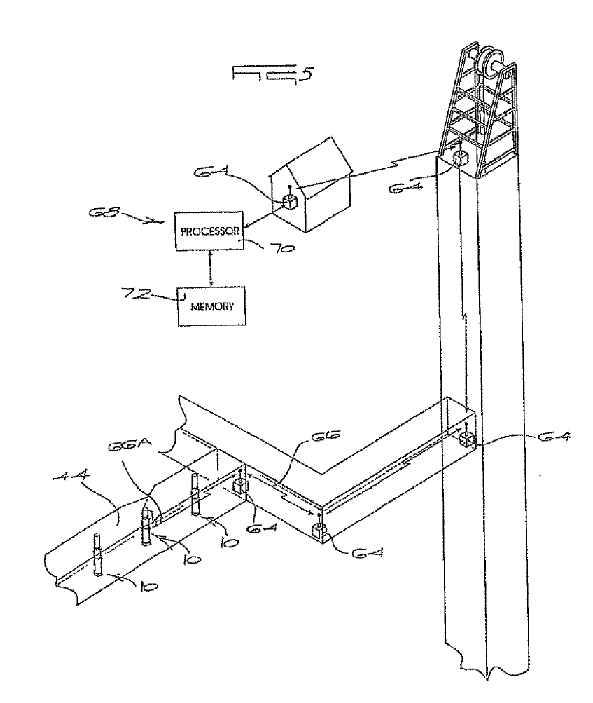

FIG. 4 shows the steps taken during a monitoring process 50 in which the first and second mechanisms 22 and 24 are monitored by the first control unit 16. A first measure 52 in the form of yielding movement of the unit is taken by the first mechanism 22 and is communicated to a processor 54 of the first control unit 16. A second measure 56 in the form of pressure in the pods which is directly related to the load on the unit, is communicated to the processor from the second mechanism 24. The processor combines the first and second measures with an identifier 58 which is stored in the memory of the first unit before being transmitted. The identifier is unique to the unit and is used for identifying the source of the data. The memory in which the identifier is stored can be an integral part of the processor or it can be stored in a part of the apparatus which is used for logging the data of the sensors.

FIG. 5 shows a method of monitoring an underground excavation 62 in which a plurality of units 12 have been installed in the underground excavation 44. A number of relay stations 64 are placed at strategically selected locations so that a signal 66 which is being transmitted from a respective transmitter 48 can be relayed to a second control unit 68 which, typically, is positioned at ground level. The second control unit includes a processor 70 and a memory 72 in which the processor stores the data received from the units.

The second control unit 68 analyses the data so that the first and second measures 52 and 56 respectively are entered into the memory 72 in the data file of the applicable unit 12. The identifier 58 is used to correlate the first and second measures with the relevant unit. It is possible to store all the data received from a particular unit 12, or from all of the units. Alternatively a specific number of measures, e.g. only the last ten measures, are stored for each unit. The amount of data stored can be selected according to requirement, depending for example on whether weekly, monthly, six-monthly or annual graphs have to be drawn for a specific group or area of units. The data is captured by computer software which has been designed for specific ground conditions.

The second control unit 68 further analyses the respective first and second measures 52 and 56 by comparing each measure with a control value which has been stored in the memory 72. If the respective measure is inconsistent with a predetermined allowable range, then an alarm 74 is activated.

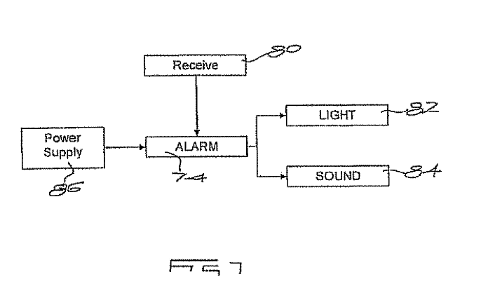

FIGS. 6, 7, and 8 show a first form 76 of the alarm 74 according to the invention, a flow chart of steps during an alarm activation process 78, and a variation 76A of the alarm arrangement, respectively.

Referring to FIG. 6, the alarm arrangement 76 is associated with a unit 12A in which the upper member 20A is manufactured from a suitable metal. Like reference numerals are used to designate like components. The alarm arrangement is mounted to the first control unit 16, but this combination is merely illustrative and is not limiting.

A return signal 66A is received from the second control unit 68 in which the first control unit 16 is instructed to activate the alarm 74. In response to the return signal 66A, the alarm arrangement is used to activate a light 82, which can be configured to flash or to be constant, or to sound an audible alarm 84. The arrangement draws power from a power supply 86 which can be the same power supply from which the first control unit obtains its power. Alternatively a replaceable battery pack can be used to power the alarm arrangement.

In a variation of the invention an alarm arrangement 76A is attached to a safety helmet 88 which is worn by a user 90 e.g. a miner. The alarm arrangement 76A draws power from a small power source or battery pack which is installed inside a housing 92 of the arrangement which includes a siren and a receiver, not shown. Suitable electronic circuitry is used to operate the siren and receiver. The receiver captures the return signal 66A and communicates the signal to the processor 98 which, in turn, decodes the signal and in response thereto activates the siren to warn the user 90 of a dangerous condition.

The first mechanism 22 senses closure of the monitoring unit. As the upper member is moved, as a result of the yielding action of the unit, towards the lower member, the wheel 26 is turned. The rotational movement of the wheel is communicated via the circuitry 34 to the first control unit 16.

When, for example, the upper member 18 experiences sudden movement, or the load placed on the unit 12 exceeds a predetermined value, the second control unit 68 sends the return signal 66A to the excavation 44 using the relay stations 64 so that the respective alarms 74 are activated. The return signal 66A can be used to activate only a particular alarm arrangement 76 through the use of the identifier, but preferably is used to activate all of the alarm arrangements 76 and 76A.

The return signal can be used by the second control unit 68 to carry out any of the following functions: activating the respective alarm 74, deactivating the respective alarm, and instructing the respective first control units 16 to retransmit the return signal.

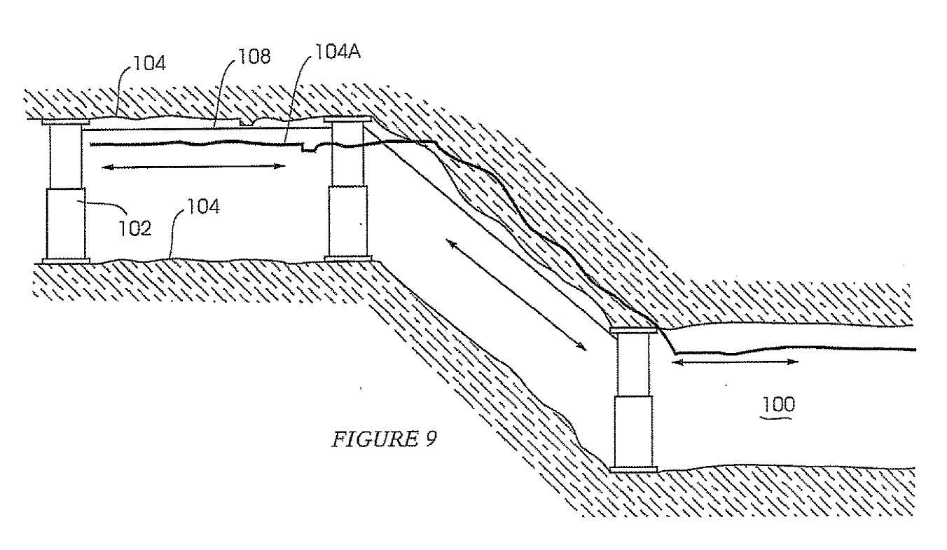

FIG. 9 illustrates a further possible feature of the invention. In the preceding description reference has been made to possible closure between a hanging wall and an opposed footwall and the monitoring of such closure. Other types of rock movement are however possible and can pose equal threats to the safety of personnel.

FIG. 9 illustrates an underground excavation 100 which is at different levels. Elongate supports 102 of any appropriate kind extend between opposed hanging and footwalls 104 and 106 respectively, at appropriate locations. The footwall is shown in two possible positions marked 104 and 104A respectively. The movement of the hanging wall from one position to the other is indicative of relative transverse movement of the rock bodies taking place—such movement may or may not be accompanied by closure of the hanging and footwall. Nonetheless this type of movement is indicative of stress release and can be a precursor to a rock fall or other dangerous underground event. To assist in detecting this type of movement additional monitoring apparatus 108 is employed. This apparatus can take on different forms. A distance measuring device based on the use of lasers can for example be employed to monitor the spacing between any adjacent pair of the supports. Any meaningful variation in the distance between adjacent supports is indicative of lateral or transverse relative movement. A linkage could replace a laser-based distance measuring arrangement or, in its simplest form, use could be made of cords or other mechanisms which are spanned between adjacent pairs of supports. A change in the tension or slacking in a linkage of this type is indicative of relative transverse movement taking place and, if detected timeously, a warning signal can be transmitted, using the arrangements already referred to hereinbefore to personnel to alert them of the impending danger.

The invention provides an apparatus for and a method of monitoring an underground excavation in which closure of a hanging wall towards a footwall, transverse movement of the hanging wall relative to the footwall, and the force placed on an elongate unit which is installed between the hanging wall and the footwall, are measured. At a remote location comparisons are made between control values and the measures received from the elongate unit so that it can be determined whether a dangerous condition exists at the location where the unit is installed. Appropriate action can then be taken.

1. A monitoring arrangement for use in an underground excavation which includes an elongate support unit between a hanging wall and an opposing footwall in the excavation, a sensing arrangement which is responsive to load which in use is placed on the elongate support unit, and a first control unit which monitors the sensing arrangement.

2. A monitoring arrangement according to claim 1 which includes a mechanism for logging or transmitting data received from the sensing arrangement

3. A monitoring arrangement according to claim 2 wherein the sensing mechanism includes a transmitter.

4. A monitoring arrangement according to claim 2 wherein the elongate support unit is telescopically extensible and includes a lower member and an upper member which is slidably engaged with the lower member.

5. A monitoring arrangement according to claim 4 wherein the sensing arrangement includes a first sensor which senses longitudinal movement of one end of the elongate support unit relative to an opposing end.

6. A monitoring arrangement according to claim 5 wherein the first sensor includes a measuring device at an interface between the upper and lower members which senses longitudinal movement of one member relative to the other member.

7. A monitoring arrangement according to claim 1 wherein the sensing arrangement includes a pod, which is placed between an end of the elongate support unit and an opposing rock surface, which can be pressurised so that the unit is pre-stressed, and a second sensor which senses the internal pressure of the pod.

8. A monitoring arrangement according to claim 1 which includes an alarm enunciator which is activated upon at least one of the following: movement of one end of the elongate support unit relative to an opposing end beyond a predetermined distance, or in excess of a predetermined rate; and when the force on the elongate support unit, in an axial direction, exceeds a predetermined level.

9. A monitoring arrangement according to claim 8 which includes an enunciator which is operable in response to the first control unit.

10. A method of monitoring a support arrangement in an underground excavation which includes the steps of installing a sensing arrangement on an elongate support unit in a support location in the underground excavation, connecting a first control unit to the sensing arrangement, and monitoring the sensing arrangement with the control unit to determine a load which in use is placed on the elongate support unit.

11. A method according to claim 10 which includes the step of transmitting data received from the sensing arrangement to a second control unit which is situated at a location remote from the sensing unit.

12. A method according to claim 11 which includes the step of using data, received by the second control unit, to control at least one of the following: activating an alarm system; deactivating an alarm system; and transmitting data from the second control unit.

13. A method according to claim 10 which includes the step of retrieving a unique identifier from a memory of the first control unit, and transmitting the unique identifier and data from the sensing arrangement.

14. A support monitoring system which includes at least a first elongate support unit at a support location in an underground excavation, a sensing arrangement which determines a load placed on the first elongate support unit during use, a first control unit which monitors the sensing arrangement, a mechanism for transmitting data from the sensing arrangement, and a second control unit which receives the data and which stores the data in memory.

15. A method of monitoring an underground excavation which includes the steps of installing at least one elongate support unit at a support location in the excavation between a hanging wall and an opposing footwall, monitoring the elongate support unit to obtain a first measure which is indicative of closure of the hanging wall and the footwall, and a second measure of a load on the elongate support unit, and generating an alarm if the first measure exceeds a predetermined value or takes place at a rate which is in excess of a predetermined rate, or if the second measure exceeds a predetermined level.

16. A method of monitoring an underground excavation according to claim 15 wherein a plurality of elongate support units are installed in the excavation and wherein the method includes the steps of transmitting at least the first measure of each elongate support unit to a remote location and logging the respective first measures at the remote location.

17. A method of monitoring an underground excavation according to claim 16 which includes the step of analysing data, relating to the first measures, at the remote location.

18. A method of monitoring an underground excavation according to claim 17 which includes the step of transmitting an alarm signal to the excavation so that a visual alarm or an audible alarm, or both, are activated when the analysed data indicates a dangerous condition.

19. A method of monitoring an underground excavation according to claim 18 which includes the step of using the alarm signal to activate a light on at least one helmet, belt or other item, which is worn by a miner in the underground excavation.

20. A support monitoring system according to claim 14 which includes at least a second elongate support unit, and apparatus for detecting relative movement of at least part of the first elongate support unit transversely to the second elongate support unit.

21. A support monitoring system according to claim 20 wherein the data detected, due to the relative transverse movement of an elongate support unit is directed to the transmitting mechanism.

22. A support monitoring system according to claim 20 which includes an apparatus to detect relative transverse movement which is not coincident with a longitudinal dimension of one of the elongate support units by using electromagnetic signals or a cord or linkage which extends between two units and which is arranged so that a change in the tension or slack in the cord or linkage is indicative of relative transverse movement of the elongate support unit.

23. A monitoring arrangement according to claim 3 wherein the elongate support unit is telescopically extensible and includes a lower member and an upper member which is slidably engaged with the lower member.
